(19) United States
(12) Patent Application Publication
(10) Pub. No.: US 2002/0005469 A1
(43) Pub. Date: Jan. 17, 2002

(54) Micro sun sensor using a hologram

(76) Inventors: Marzouk Marzouk, Annapolis, MD (US); Jacobo Marcos Sirota, Takoma Park, MD (US)

Correspondence Address: Marzouk Marzouk, 770 Eastern Point Road, Annapolis, MD, 21401, US

(21) Appl. No.: 09/759,442

(22) Filed: Jan. 16, 2001

Related U.S. Application Data
(60) Provisional application No. 60/176,439, filed on Jan. 14, 2000.

(51) Int. Cl. G01C 21/02

(52) U.S. Cl. 250/203.4

(57) ABSTRACT

A novel concept for high-resolution attitude determination sun sensor, which reduces mass and power of current commercial technology sensors by orders of magnitude, while at the same time providing high resolution and a very wide field of view. The sensor is based on a few basic principles and state of the art technology. The wide FOV, high resolution, and compact size are achieved by overlapping fields-of-view onto a single high-resolution detector using holographic technology. Overlapping the fields of small angular sectors in the field of view of a fine sensor permits sharing a single high-resolution focal plane array of a moderate size among sectors. For a given array size it allows to spread the signal in the elevation direction over N times the number of pixels that a sensor with a single sector and the same system field of view would have used. thus creating a system that overcomes the inherent problems of wide field of view systems, namely, low resolution.

### CROSS REFERENCE TO RELATED APPLICATIONS

Provisional Patent, application No. 60/176,439 Filing date Jan. 14, 2000.

### STATEMENT REGARDING FEDERALLY SPONSORED RESEARCH OR DEVELOPMENT

The creation of this invention was not federally sponsored.

### REFERENCE TO MICROFICHE APPENDIX

No microfiche appendix is included.

### BACKGROUND OF THE INVENTION

1. Field of the Invention

This invention relates generally to the field of remote sensors and optical elements, namely holograms. By incorporating the use of volume holographic elements, along with standard optical elements, a new variety of sun sensor is created.

2. Statement of the Problem

In a standard sun sensor, significant challenges arise from the inherently conflicting requirements of high angular resolution and wide field of view. In addition, current sun sensors are relatively large instruments that consume a significant amount of power.

Historically, one-axis digital sensors (where digital refers to the direct encoding of the sun image into a Gray code or binary reticle of on/off sensors) have been used for attitude determination for decades. However, due to the large angular extent of the sun disk (0.53 degrees) these sensors are limited to about 1/8-degree resolution (1/4 of the sun), even when using a few interpolating bits. For comparison, the planned resolution of 9 arc seconds called for in this invention means that the sun's position is to be resolved to better than 1/200th of its dimensions

3. Discussion of Prior Art

A number of patents involving sun sensors and holograms are noted in the late to the issue of prior art;

| U.S. Patent Documents | | | |
|---|---|---|---|
| 5206499 | Dec. 20. 1991 | Mantravadi, et al. | 250/203 |
| 5914483 | June 22, 1999 | Fallon, et al. | 250/203 |
| 5319496 | June 7, 1994 | Jewell, et al. | |
| 5515354 | May 7, 1996 | Miyake, et al | |
| 6127067 | Dec. 5, 2000 | Orr, et al | |
| 5282066 | Feb. 19, 1991 | Vick | |

Discussion of the Related Art

In order for satellites to have accurate attitude control on a continual basis, different types of instrumentation must be employed. These include gyroscopes, star trackers, and sun sensors.

Gyroscopes are normally used in instances where other types of instruments cannot function. However, they are subject to rate drift and need to be periodically calibrated using more accurate instruments.

Star trackers can produce accurate attitude control but their operation is complicated. Star trackers can be used for attitude control as long as a sufficient number of stars are within the detectors field of view. The information that is collected is compared with information contained in a star database. Due to the enormous amount of data in the star database, the satellite's general position must be known beforehand in order to limit the search range in the database. In addition, unless the satellite's computer is able to make the necessary computations, the information will need to be sent down to Earth for computation and then sent back to the satellite.

Sun sensors use the sun as a reference for attitude control. Their operation may not be as accurate a star tracker's, but they are much simpler and use much less computing cycles.

Current sun sensors typically use either a lens to focus the sun's image on a pixilated detector or one or more apertures to focus the image onto a linear detector array. Both of these methods are subject to the tradeoffs between large fields of view and high angular resolution. One potential solution to this problem is the use of a fixed high resolution system and a rotating scan mirror. While such a system may solve the resolution and large field of view problem it has problems of its own, including errors in the mirror angular position and significant power and penalties.

Our proposed sun sensor employs a holographic element to simultaneously simulate an array of fixed mirrors; designed to be used along with a fixed focusing element to provide a stationary sensor that yields a narrow, high resolution multiple field of view instrument and is meant to be used in tandem with a wide field of view coarse system.

Our design is different from another proposed hologram-based system (U.S. Pat. No. 5,206,499) in that we are not proposing to implement a holographic telescope nor a holographic focusing element. Instead, we use a multiplexed hologram of a fixed array of mirrors to direct the image of the sun onto a detector. In addition, our approach does not include the use of a Schmidt telescope.

A number of patents involving holograms are noted in the public record. And relate to the issue of prior art;

In ref U.S. Pat. No. 5,319,496, a system is described for combining a plurality of light beams from a plurality of sources, into a single beam. In our application a single source is directed onto a detector in order to track the position of that one object within a field of view.

In Ref. U.S. Pat. No. 5,515,354 an holographic element is used to direct a single light beam onto detector, a hologram of a single mirror. In our case, however, we record a number of holograms representing a sequence of mirrors, of different angular positions with respect the axis of the detector.

### BRIEF SUMMARY OF THE INVENTION

The sensor is based on a few basic principles and state of the art technology. The wide FOV, high resolution, and compact size are achieved by using a volume hologram to simultaneously simulate an array of mirrors at fixed angles relative to each other, thus directing overlapping fields-of-view onto a single high-resolution detector using holographic technology. Overlapping the fields of small angular sectors in the fine sennsor's field of permits the sharing of a single moderately sized high-resolution focal plane among all sectors. For a given array size it allows the signal's elevation component to be spread over N times the number of pixels than a sensor with a single sector and the same system field of view would have used. Thus creating a system that overcomes the inherent problems of wide field of view systems, namely, low resolution.

In addition, the compact nature of the hologram allows for the significant miniaturization of the sensor by a factor nominally equivalent to the number of overlapping fields squared. The use of a single small focal plane array conserves the electric power, reduces the mass and the size of the system, and avoids the use of complex multi-element optics. Volume holography offers a significant advantage of combining several optical elements in a single holographic element. Holograms are well known and are used in a number of applications

### BRIEF DESCRIPTION OF THE DRAWINGS

FIG. 1 is a schematic diagram of the optical system showing both coarse and fine sensors used to accurately determine the position of the sun to a high degree of accuracy.

FIG. 2 is a diagram depicting the fine sensor optical system, including a beamsplitter, volume hologram and focusing fold mirror

FIG. 3 is a diagram depicting holographic multiplexing within a volume hologram which can be fabricated by existing technology, the method of fabrication being known in the art

FIG. 4 shows the relationship between the coarse and fine sensors as the sun's image impinges onto different regions of the detector.

FIG. 5 shows the electrical block diagram depicting the merging of coarse and fine sensor data.

### DETAILED DESCRIPTION OF THE INVENTION

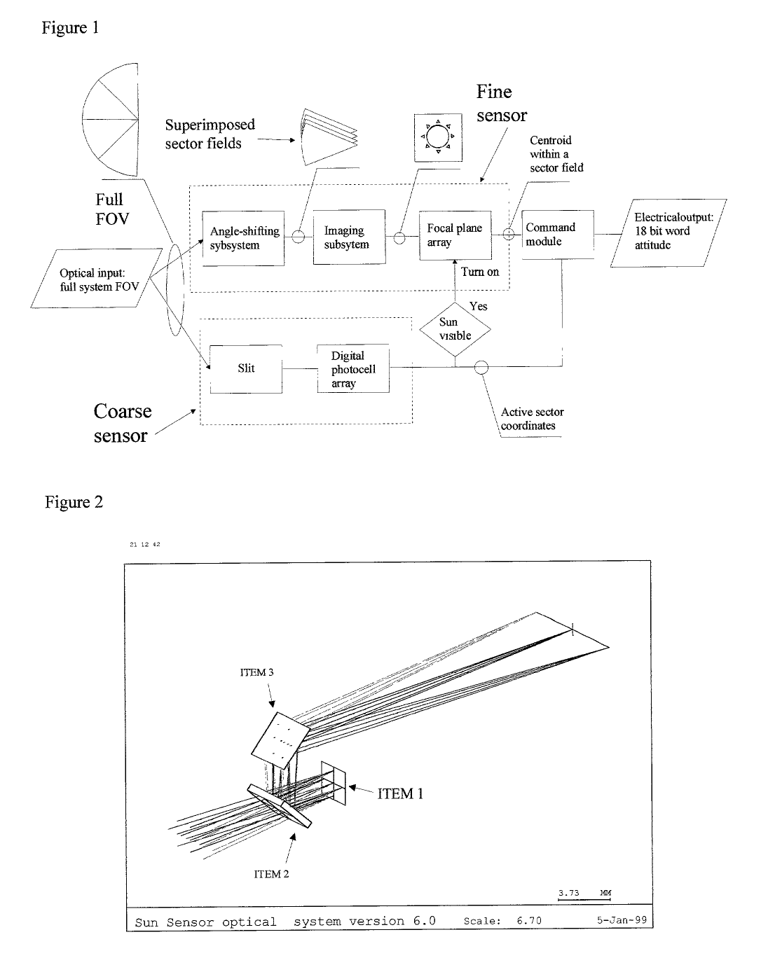

The optical functional block-diagram of the sensor is shown in FIG. 1. The sensor consists of a coarse and a fine sensor, each of which comprises optical, electronic and mechanical subsystems. The details of the design and operation of each of the subsystems are described below.

1. Fine Sensor Description

The functions of the fine sensor optical subsystem are:

1) To collect light within the system field of view (wide in the elevation plane, narrow in the azimuth plane);

2) To separate the system field of view into sectors within the elevation plane, each sector spanning the field of view of the fine sensor;

3) To superimpose the field of these sectors and direct them onto the focal plane array.

The fine sensor can be separated into the angle-shifting sub-system, which collects the light and superimposes the fields from of all the sectors, and the imaging subsystem, which forms an image of the sun on the focal plane array.

The angle-shifting sub-system is functionally equivalent to a fold mirror with a changing angular position. Here we propose the use of a volume hologram which is created to be functionally equivalent to an array of static mirrors positioned at different tilt angles. Such an element may be created using a fabrication method known in the art.

The imaging subsystem may consist of a standard optical element such as a lens or reflective mirror which focuses the incoming light onto a detector, such elements being well known in the art. (U.S. Pat. No. 6,127,067 and U.S. Pat. No. 5,282,066).

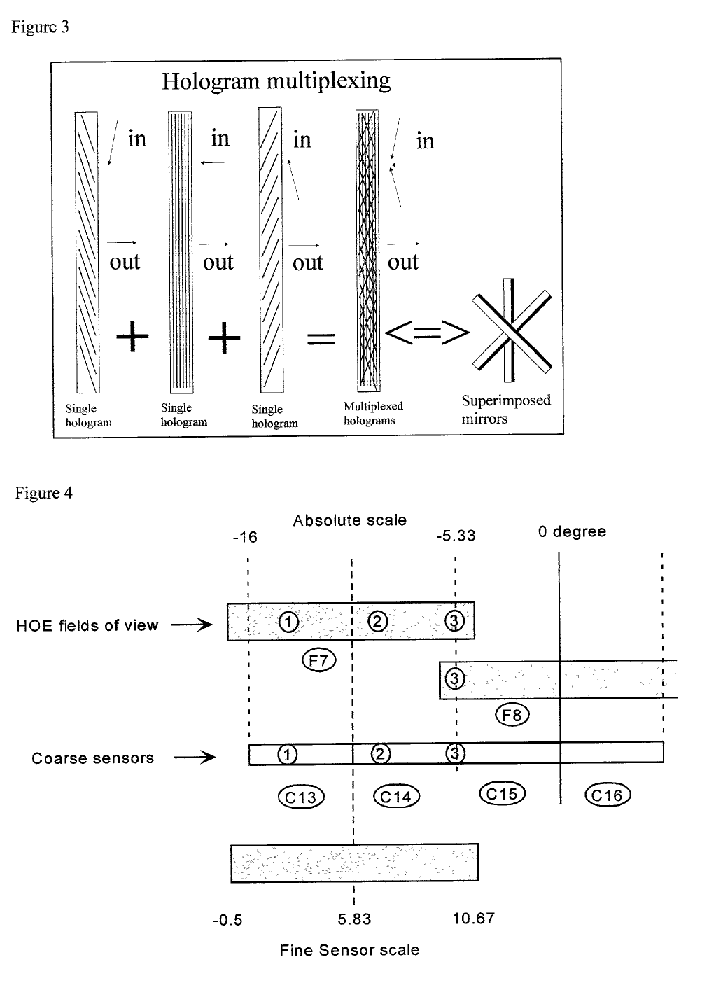

The holographic element is a small flat element shown as Item 1 in FIG. 3. There are a number of holograms multiplexed within the volume holographic element, which represent mirrors tilted at different angles in order to cover the entire field of view of the system. A particular grating, depending on the angular position of the sun with respect to the sensor reflects the sunlight reaching the holographic element. A beamsplitter, item marked “ITEM 2”, positioned in front of the holographic element, picks off the light reflected by the holograms and directs it out of the elevation plane. Then a focusing folding mirror, marked “ITEM 3”, focuses the light and directs the light toward the focal plane array. The beamsplitter, the holographic element and the focusing fold mirror comprise the imaging subsystem. Since sun light is not monochromatic, a bandpass wavelength filter is used (positioned between the beamsplitter and the fold mirror, not shown in the figure) to reduce the background signal from the polychromatic stray light entering the system.

The coarse sensor consists of a slit and a photodetector. Such coarse sensors are in wide use, and are well known in the art. The coarse sensor identifies the active field of view sector, and is used to determine the coarse angular position of the sun.

The outputs of the coarse and fine sensors are combined within the command module to create an electrical output consistent with the angular location of the sun

2. Electronic Subsystem

The electronic subsystem is depicted in FIG. 4. The role of the electronic subsystem is to digitize the image of the sun disk and to feed it to the computational module. This function is accomplished by a focal plane array (FPA). The FPA will be a CMOS imaging array. The exposure parameters of the FPA are controlled using the input from the coarse sensor and command module, which sends the on/off commands, depending on whether or not the sun is within its field of view. The command functions are implemented in the field programmable gate array (FPGA) used in the computation and command module.

The FPA has 512 pixels in the elevation axis direction and an elevation field of view of 11.67 degrees. By computing the sun disk centroid with a precision of just 1/8 of a pixel, the sun's position can be established to less than 9 arcsec in elevation.

The fine sensor's elevation field of view is mapped onto the 161-degree system field of view by 15 holograms (one per sector). Each sector has 0.5 degrees of overlap between the adjacent sectors in the elevation axis. This arrangement enables seamless tracking of the sun between the sectors using the information supplied by the coarse sensor, as explained in the Computation and Command Module section.

3. Coarse Sensor

The coarse sensor subsystem will be a classical digital sensor using a slit and a Gray code reticle. The sensor reticle pattern will be deposited on one side of a glass slide, with the slit on the other side.

The light detector will be an array of seven photolithographically deposited photovoltaic cells. These include an automated-threshold-adjust strip, a sign bit, and five angle determination bits. Such detectors are well known in the art.

The coarse sensor has an elevation field of view of 180 degrees and azimuth field of view of 1 degree. It divides the system field of view in elevation plane into 32 segments of 5.33 degrees each.

The function of the coarse position sensor is: 1) to locate the sun in one of the 5.33-degree segments; 2) to activate the fine sensor circuits when the sun is within its field of view.

Two extreme sun position detectors will be used to determine if the sun elevation is below −80 or above +80 degrees.

The output of the coarse sensor is a 5 bit Gray code which is converted to binary either by a look up table or by a simple logical operation of XOR functions. The four most significant bits determine which of the 15 holograms is directing the sunlight onto the fine sensor and provides the upper four bits of the sun position. The fifth bit determines if the light is directed onto the lower or upper half of the fine sensor.

4. Computation and Command Module

As described above, the sun sensor contains three different kinds of detectors to locate the sun: 1) a fine position CMOS array detector; 2) a coarse position photovoltaic cell array; and 3) two extreme sun position detectors.

In the instrument the fine sensor carries the entire measurement function and the coarse sensor is used only as a “sector” identifier. This way we avoid the common problem of the “coarse+fine” alignment, which is illustrated below.

Typically, whenever a measurement device comprises a coarse sensor and a fine interpolating sensor, there is a critical need to align them to ensure that both sensors transition simultaneously. For example, if the coarse sensor changes its output from 5 to 6, the fine sensor reading also changes from its maximum value (e.g. 0.999), to its minimum value (e.g. 0.001). If both do not change at the same instant, it is possible to interpret the result as 5.999, 5.001, 6.999, or 6.001. The values 5.999 and 6.001 would be the desired result and 5.001 and 6.999 are off by one coarse sensor unit.

This important problem is avoided in the design by having the sector field of view of the fine sensor (11.67 degrees) larger than that of the coarse sector (5.33 degrees) and having the coarse sensor make the rollover decision.

FIG. 12 shows a sketch of the instrument operation. The horizontal axis is the elevation angle. Vertical lines indicate what is happening to the sun image at different parts of the instrument for each elevation. The top row shows the field of view of two holographic elements (HOE's), number F7 and F8 (where F refers to fine sensor). The second row shows the field of view of the coarse sensors 13 through 16, and the bottom row shows the field of view of the fine sensor. Because the fine sensor is reused, it is shown twice. It is important, however, to remember that there is only one fine sensor array, so that when a vertical line crosses both drawings of the fine sensor, the sun at that position will produce an image on each end of the fine sensor.

The elevation field of view of one fine sensor sector spans the range of 11.67 degrees. Each coarse sensor sector spans an elevation range of 5.33 degrees. Therefore the fine sensor is able to image and centroid more than one sun diameter above and below the limits of each coarse sensor. The operation is explained in detail in the next few paragraphs.

If the sun elevation is in position 1 (˜−13 degrees), it will be reflected by holographic grating #7, activate coarse sensor position 13 and produce one solar image on the left half of the fine sensor. The centroid calculation will be performed on pixels corresponding to angles −0.5 to 5.3 degrees. Because coarse sensor 13 is activated we know that the solar position is −16 degrees plus the results of the fine sensor output which in this case is +3 degrees for a final position of −13 degrees.

If the sun elevation is in position 2 (˜−9 degrees), it will still be reflected by holographic grating #7, but will activate coarse sensor position 14 and produce one solar image on the right half of the fine sensor. The centroid calculation will be performed on pixels corresponding to angles 5.33 to 11.67 degrees with the result expressed as an angle between 5.33 and 11.67 degrees which in this case is 7 degrees. The sun elevation is still given by −16+7 degrees for a final position of −9 degrees.

If the sun is in position 3 at the boundary between coarse sensors 13 and 14, there will be two solar images on the fine sensor. However, only one of the coarse sensor sectors will be active due to the Gray code encoding. Either image in the fine sensor that is centroided, would give the right answer, as can be seen following the steps explained above for positions 1 and 2.

Using this system the transitions from one end of the fine sensor to the other are seamless and free of gaps.

Each 8 bit data value is read in, multiplied by the row and column counter values and added to an accumulator which keeps the row sum or the column sum. The 8 bit data values are also added to compute the total solar intensity and the denominator of the centroid calculation.

After the sums have been computed the ratios are calculated. This is done by the on-board dividers.

To compute the solar centroid, the electronics must

Convert the coarse sensor Gray code to straight binary code

Establish the region of interest based on the coarse sensor and initialize the row counter

Read the image data from the region of interest and compute products and sums

Perform the divisions.

5. Command Electronics

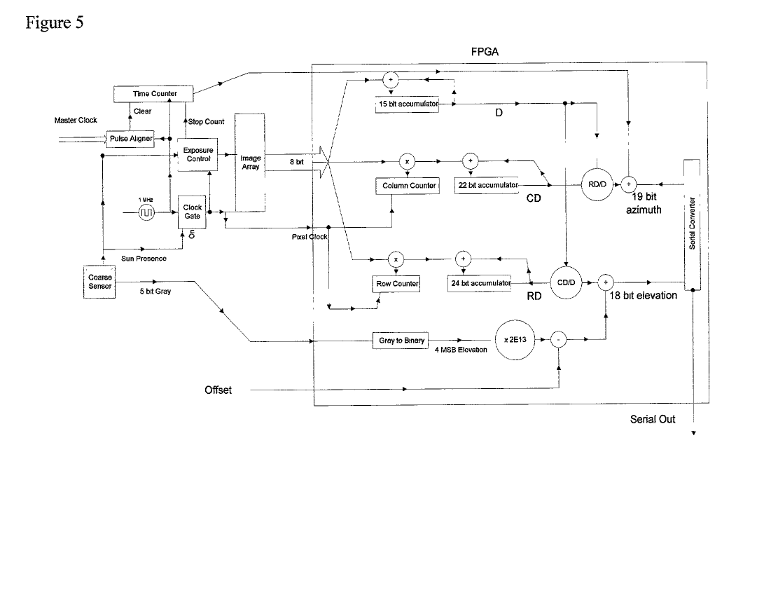

The block diagram for the electronics is shown in FIG. 5.

The electronics is divided into two major parts, each performed by a VLSI IC, and a few support functions to provide azimuth time information, provide exposure control, and control the clock to the main processor. The image is taken by a CMOS imaging array with onboard analog to digital convertor, ADC. Processing of the data is done in an FPGA.

The time between the space craft time mark and the sun present event is measured by a 22 bit counter. When the spacecraft time mark is received, the counter is set to zero. When the sun falls on the course sensor, the exposure control is activated which will stop the counter in the center of the exposure on the CMOS sensor. In this way, spacecraft rotation will elongate the sun image but not bias the sun position.

The clock to the FPGA is disabled until the sun is present on the course sensor to reduce the instrument power consumption. When the sun is present, the clock and FPGA are activated.

Once the exposure is finished, the desired part of the solar image is digitized and transferred to the FPGA where the two centroids are computed. When the sun leaves the sensor's field of view, a signal is sent to the clock gate to stop the clock to the FPGA and the instrument goes back to “sleep” until the next “sun present” signal is received.

The pixel counter will be a 10 bit counter with the count values larger than 512 used to clock out the dark reference pixels and to perform additional calculations such as the division The counter is estimated to require 10 sequential modules. The centroid calculation requires a multiplication and two additions. The full sun disk spans about 25 pixels. If each pixel is nearly saturated, then the maximum possible denominator value is 25*255=6375 which requires 13 bits to store. Even if all the pixels have a dark value of one count, the result still fits within 13 bits. An 8-bit adder with 13-bit accumulator is estimated to require 13 sequential modules. The numerator calculation requires the multiplication of a 9-bit pixel counter times an 8-bit data value and the summation of the results. The maximum numerator value is 255*sum(481:511) which is less than 4e6 and requires a 22 bit accumulator to store the result.

6. Mechanical Design

The mechanical system must accomplish the following:

Allow for mounting and alignment of the sensor to the satellite

Support optical elements to within alignment tolerance budgets

Withstand space thermal environment

Withstand launch loads

Support electrical system components

Allow for assembly alignment and integration of the Sensor components

### CONCLUSIONS, RAMIFICATIONS AND SCOPE OF INVENTION

The instrument that we have described will significantly improve the technology of satellite attitude control through the use of holographic elements. By implementing volume holographic technology along with standard optical elements, this instrument can provide both high angular resolution and wide fields of view. While other types of sun sensors provide both of these capabilities, the instrument that we have described uses different techniques that result in a lighter, smaller, more reliable and more power efficient instrument.

This use of this instrument is not necessarily limited to that of a sun sensor for satellite attitude control. While it's primary target is the sun, it may also be employed to provide satellite attitude control using the moon or the earth as a target.

We claim the following:

1. A device to capture an image of the sun comprising of
(a) a volume holographic element, wherein said element functions as an array of fixed planar mirrors that reflect light from various fields of view and superimpose such fields of view onto a single light bundle
(b) a focusing element that receives said light bundle and directs it onto a detector
(c) a detector in the form of a planar array of sensing elements, which receives said light bundle and produces one electrical signal for each sensing element whereby said image can be used to accurately determine the angle between an artificial satellite's axis of rotation and the center of the Sun

2. A method by which electrical signals from claim 1 may be processed to determine the angle between an artificial satellite's axis of rotation and the center of the Sun, comprising:
(a) providing electrical signals from said detector in claim 1
(b) providing a secondary onboard device that is capable of determining the coarse angular position of the center of the Sun relative to the artificial satellite's axis of rotation, wherein such secondary device is previously known to the art.
(c) combining such data from said devices to unambiguously determine the angular position of the sun
